(19) United States
(12) Patent Application Publication
(10) Pub. No.: US 2026/0123577 A1
(43) Pub. Date: May 7, 2026

(54) SPEED CONTROL FOR AGRICULTURAL MATERIAL TRANSFER VEHICLE

(71) Applicant: Deere & Company, Moline, IL (US)

(72) Inventors: Stephen R. CORBAN, Geneseo, IL (US); Grant J. WONDERLICH, Milan, IL (US); Brandon M. MCDONALD, JOHNSTON, IA (US)

(21) Appl. No.: 18/934,941

(22) Filed: Nov. 1, 2024

(51) Int. Cl. A01D 41/127; A01D 43/08

(52) U.S. Cl. CPC A01D 41/127; A01D 43/085

(57) ABSTRACT

A speed control system accesses a set of physical factors and a set of job-related factors and computes a target speed for a material transfer vehicle. The speed control system predicts an estimated target speed for the material transfer vehicle based on a route of the material transfer vehicle and terrain along the route. the speed control system generates a speed control signal based on the target speed and the estimated target speed.

### FIELD OF THE DESCRIPTION

The present descriptions relate to mobile agricultural machines. More specifically, the present description relates to controlling speed of an agricultural material transfer vehicle.

### BACKGROUND

There is a wide variety of different types of agricultural equipment. Some such agricultural equipment includes agricultural harvesters and material transfer vehicles. Agricultural harvesters often engage crop, process that crop, and unload that crop into a material transfer vehicle, such as a mobile crop cart or trailer (for example).

Once the material transfer vehicle is filled to a desired fill level, the material transfer vehicle navigates toward a container, such as a semi-trailer, pulls alongside the container, and transfers the harvested material to the container. As the material transfer vehicle approaches the container, a control system or operator positions an unloading spout or auger, and then, once alongside the container, engages the unloading auger on the material transfer vehicle to unload the harvested material from the material transfer vehicle into the container.

The discussion above is merely provided for general background information and is not intended to be used as an aid in determining the scope of the claimed subject matter.

### SUMMARY

A speed control system accesses a set of physical factors and a set of job-related factors and computes a target speed for a material transfer vehicle. The speed control system predicts an estimated target speed for the material transfer vehicle based on a route of the material transfer vehicle and terrain along the route. the speed control system generates a speed control signal based on the target speed and the estimated target speed,

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial block diagram of one example of an agricultural system.

FIG. 2 is a partial pictorial, partial block diagram of one example of an agricultural system.

FIG. 3 is a block diagram showing one example of an agricultural system.

FIGS. 4A and 4B (collectively referred to herein as FIG. 4) are a block diagram showing one example of a propulsion vehicle speed control system in more detail.

FIGS. 5A, 5B, and 5C (collectively referred to herein as FIG. 5) illustrate a flow diagram showing one example of the operation of the propulsion vehicle speed control system.

FIG. 6 is a block diagram showing one example of the agricultural system shown in other figures, deployed in a remote server environment.

FIGS. 7, 8, and 9 show examples of mobile devices that can be used in the architectures and systems shown in other figures.

FIG. 10 is a block diagram showing one example of a computing environment that can be used in the systems and architectures shown in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, agricultural harvesters often unload harvested material into a material transfer vehicle. The material transfer vehicle then transfers the material to the location of a container where the material transfer vehicle unloads the material into the container. The container may be a haulage vehicle (such as semi-trailer or a grain truck) or another type of container. It will be understood that a material transfer vehicle includes a material container or receptacle (e.g., a cart, a trailer, a hopper, etc.) that includes a volume configured to receive and hold material (e.g., crop material such as grain, etc.) and a propulsion system that provides for travel of the material transfer vehicle. In some examples, the material transfer vehicle can include a separate towing vehicle including the propulsion system and a towed material container or receptacle, such as a grain cart or trailer towed by a towing vehicle, such as a tractor. In some examples, the propulsion system and material container or receptacle may be a on the same (or supported by) the same frame, such as in the case of a self-propelled material transfer vehicle (e.g., a truck with an on-board material container or receptacle).

In order to increase productivity during the harvesting operation, it may be desirable for the material transfer vehicle to travel as quickly as possible through the field, between the combine harvester and the container. However, the physical properties of the material transfer vehicle (e.g., mobile grain cart, etc.) may change during the harvesting operation. For instance, the material transfer vehicle may be more or less full of material (e.g., grain, etc.) at different times, thus changing the center of gravity of the material transfer vehicle. In addition, the environmental properties where the material transfer vehicle is operating may change as well. For instance, the terrain may be rolling so that the pitch and/or roll of the material transfer vehicle changes during operation. Similarly, the route of the material transfer vehicle may have turns that may affect the desired speed of travel, especially when the material transfer vehicle is full. The problem of increasing the efficiency by controlling the speed of the material transfer vehicle can be exacerbated during automated or semi-automated operation.

Thus, the present description proceeds with respect to a system that includes a speed control system. The speed control system senses or obtains access to physical factors corresponding to the material transfer vehicle and job-related factors. The physical factors characterize, for example, physical attributes of the machine, environment, machine dynamics or kinematics. The physical factors may include such things as the weight of the material container (e.g., grain cart), the center of gravity of the material container (e.g., grain cart), material container (e.g., grain cart) properties (such as whether the material container (e.g., grain cart) has tracks, tires, etc.), the tire pressure, the pitch and roll orientation of the material container (e.g., grain cart), ground conditions (such as soil type, soil softness, wetness, etc.), the turn or yaw rate corresponding to a route that the material transfer vehicle is following, loads and/or accelerations on the material transfer vehicle such as, but not limited to, drawbar load and/or acceleration on the drawbar, among other factors. The job-related factors characterize, for example, the operation or job being performed by the material transfer vehicle. The job-related factors may include such things as whether a haulage vehicle (such as a semi-truck) is waiting to receive material from the material transfer vehicle, a time indicator indicative of when the combine harvester will be full and ready to unload, an indication of whether load data is being collected (such as whether the propulsion vehicle needs to stop before unloading, take a weight or mass measurement, then stop after unloading and take another weight or mass measurement), among other job-related factors. Based upon the physical factors and job-related factors, the speed control system computes an output indicative of a current target speed for the propulsion vehicle at a current time. The speed control system can also consider physical factors and job-related factors to generate a predicted or estimated target speed value that indicates the target speed of the material transfer vehicle at a time in the future (such as at a point where the material transfer vehicle is further along the route being followed by the material transfer vehicle). Based upon the current target speed and the estimated target speed, the speed control system generates a speed control signal to control the speed of the propulsion vehicle.

In one example, the speed control system can also detect or access feedback (such as sensor readings indicating how close the material transfer vehicle (or a portion thereof such a the material container (e.g., grain cart) is to tipping over, the estimated stopping distance for the material transfer vehicle, different accelerations and forces that are currently being detected on the material transfer vehicle, etc.) and modify the current target speed and estimated target speed based upon the feedback.

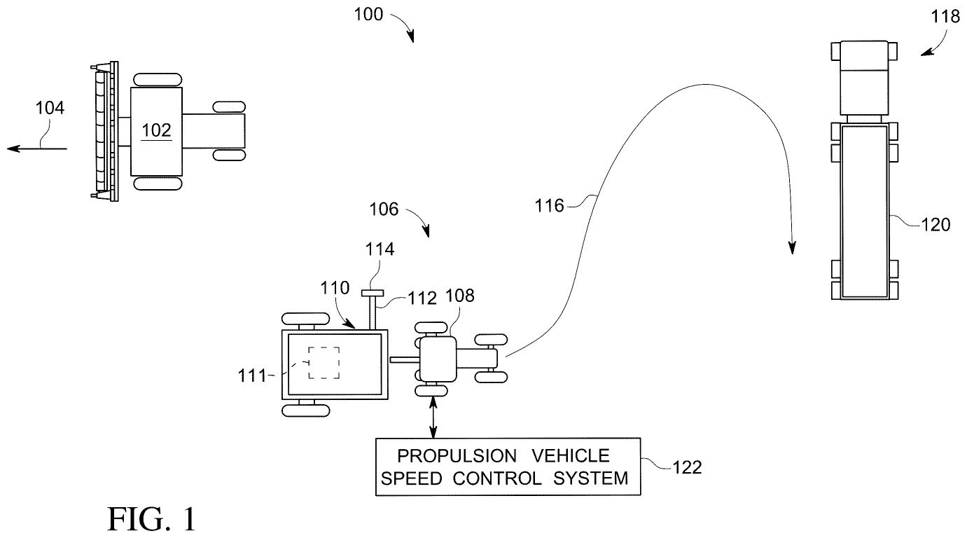

FIG. 1 is a pictorial illustration of one example of an agricultural system 100 in which a harvester 102 is moving through field in a direction indicated by arrow 104. A material transfer vehicle 106 includes a propulsion vehicle (e.g., a tractor) 108 and a grain cart 110. Grain cart 110 is shown having a conveyor 112 and a spout 114 that are used to unload harvested material from grain cart 110. Conveyor 112 may be a conveyor (such as an auger) that conveys material from grain cart 110 through a housing and out an exit end of conveyor 112. Spout 114 may be disposed on an exit end to direct material as the material exits through the exit end of conveyor 112. FIG. 1 also shows that grain cart 110 has a gate 111 disposed at the bottom of grain cart 110. In order to facilitate the transfer of material out of grain cart 110, the gate 111 is opened to a desired position which allows the grain to fall into a hopper or in another collection basin where the grain can be transferred by conveyor 112.

In the example shown in FIG. 1, grain cart 110 has been filled with harvested material from harvester 102 and is traveling along a travel path indicated by arrow 116 toward a container (e.g., in the example shown in FIG. 1 the container is a semi-truck) 118. In order to unload material from grain cart 110, an operator (a human operator, an autonomous operator, or a semi-autonomous operator) actuates an actuator to position conveyor 112 to a deployed position. Tractor 108 pulls the grain cart 110 alongside of semi-trailer 120 so that the conveyor 112 can be engaged to transfer material from grain cart 110 into semi-trailer 120. In one example, the spout 114 is movable to change the direction of material exiting conveyor 112 and to thus change the landing point of material inside semi-trailer 120. Also, in one example, conveyor 112 is driven by a power take off on tractor 108, although it may be driven by other actuators as well. The speed of the power takeoff or other actuator can be controlled to change the landing point as well.

As discussed above, in order to increase the efficiency of the harvesting operation, it may be desirable to have material transfer vehicle 106 travel as quickly as possible between harvester 102 and container 118. However, the conditions in the field and the conditions on material transfer vehicle 106 may change during the harvesting operation and may thus affect the desired speed of material transfer vehicle 106. For instance, as material transfer vehicle 106 is traveling along route 116, material transfer vehicle 106 may encounter terrain that is sloped, rough, muddy, or has other characteristics that may affect the desired speed of material transfer vehicle 106. Similarly, when material transfer vehicle 106 is traveling along route 116, grain cart 110 may be full of harvested material which may change the location of the center of gravity of grain cart 110 over that when grain cart 110 is empty or is only partially full.

Also, job-related factors may influence the desired or target speed of material transfer vehicle 106. For instance, if a container (e.g., a haulage vehicle) 118 is empty and is waiting to be loaded by material transfer vehicle 106, then the target speed for material transfer vehicle 106 may be increased over a scenario where no container 118 is waiting for material transfer vehicle 106. As an example, it may be that a container (e.g., haulage vehicle) 118 is still far enough away (e.g., in time or distance) from the field being harvested such that the haulage vehicle is not waiting or will not be waiting on the material transfer vehicle 106. In that case, there is no need to increase the travel speed of material transfer vehicle 106 along route 116, as the increased speed would likely reduce fuel efficiency and would not increase the efficiency of the harvesting operation. However, when a haulage vehicle 118 is empty and is waiting to be loaded with material from material transfer vehicle 106, then the target speed of material transfer vehicle 106 may be increased to avoid the haulage vehicle 118 having to wait, idling or in another state, which would reduce efficiency.

Therefore, in the example shown in FIG. 1, agricultural system 100 includes propulsion vehicle speed control system 122. Propulsion vehicle speed control system 122 can sense or access physical factors (such as the weight and center of gravity of grain cart 110, the fill level of grain cart 110, whether grain cart 110 has wheels or tracks, the tire pressure on grain cart 110, the accelerations and loads (e.g., drawbar accelerations and loads) on tractor 108, or other physical factors). Propulsion vehicle speed control system 122 can also sense or access job-related factors (such as whether a haulage vehicle 118 is waiting for material transfer vehicle 106, whether combine harvester 102 is full and needs to be unloaded, and other job-related factors). Based upon the physical factors and job-related factors, propulsion vehicle speed control system 122 can generate a speed control signal to control the ground speed of propulsion vehicle (e.g., tractor) 108.

In addition, in one example, propulsion vehicle speed control system 122 may receive an input identifying of the route 116 that material transfer vehicle 106 is about to travel. Propulsion vehicle speed control system 122 can access other physical factors corresponding to material transfer vehicle 106 (such as the terrain along route 116, the soil conditions along route 116, the curvature of turns on route 116, and other physical factors) as well as job-related factors corresponding to material transfer vehicle 106 (such as whether a haulage vehicle 118 is about to return to the field where the harvest is being performed, and other job-related factors) and generate a predicted or estimated future target speed for material transfer vehicle 106. The predicted or estimated future target speed may indicate the target speed of material transfer vehicle 106 as material transfer vehicle 106 travels along route 116.

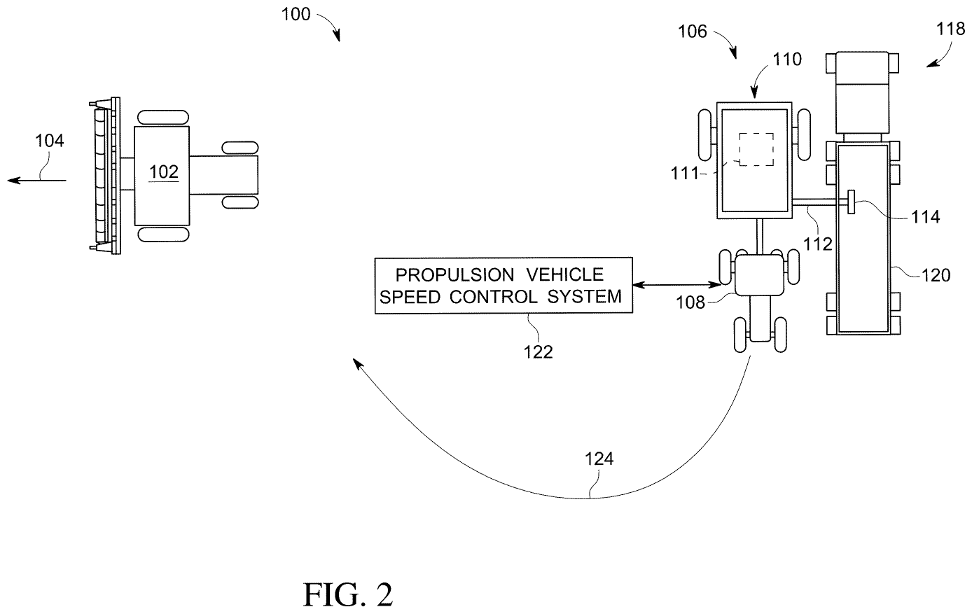

FIG. 2 is a partial pictorial, partial block diagram of agricultural system 100. Some items in FIG. 2 are similar to those shown in FIG. 1 and are similarly numbered. However, FIG. 2 shows that material transfer vehicle 106 has now pulled alongside haulage vehicle 118 so that the spout 114 is positioned over semi-trailer 120. Thus, material transfer vehicle 106 can be controlled to move along semi-trailer 120 as material is unloaded from grain cart 110 into semi-trailer 120.

Once the unloading operation is complete (e.g., when grain cart 110 is empty, or semi-trailer 120 is full), then material transfer vehicle 106 can continue along the route indicated by arrow 124 back to agricultural harvester 102 or to a different agricultural harvester or to a different location. It will be noted that the physical factors corresponding to material transfer vehicle 106 in FIG. 2 are different from those in FIG. 1. In FIG. 2, the grain cart 110 is being unloaded, or has been unloaded. Thus, the weight of material in grain cart 110, the location of the center of gravity of grain cart 110, and other physical factors corresponding to material transfer vehicle 106 may be different from those in FIG. 1.

The job-related factors corresponding to material transfer vehicle 106 may be different as well. For example, in FIG. 1 there may have been a haulage vehicle 118 waiting for material transfer vehicle 106 so it may be desirable to increase the speed of material transfer vehicle 106 as it moves to haulage vehicle 118. However, in FIG. 2, the harvester 102 may not yet be full so there is no need to increase the speed of material transfer vehicle 106 as it returns to harvester 102. Thus, propulsion vehicle speed control system 122 can sense or access the physical factors and job-related factors corresponding to material transfer vehicle 106 as it is unloading material into semi-trailer 120 and after it has unloaded material into semi-trailer 120 and is about to drive back to agricultural harvester 102 along route 124 and generate a new current target speed for material transfer vehicle 106 and a new estimated future target speed for material transfer vehicle 106.

Also, during operation, propulsion vehicle speed control system 122 can detect or access feedback parameters which may indicate whether the current target speed of material transfer vehicle 106 is correct or should be modified. For instance, grain cart 110 may have one or more scales disposed on its axle or elsewhere. The scales thus give weight measurements which are indicative of the distribution of material in grain cart 110 and which may also be indicative of the weight being exerted on each of the wheels. Such measurements may be useful in determining the stability of material transfer vehicle 106. For instance, assume that material transfer vehicle 106 is making a sharp turn. The weights on the axles may be used to determine whether the current target speed for propulsion vehicle 108 is so high that, given the turn angle or yaw rate of grain cart 110, the inner wheel has become unweighted. In that case, this may indicate that grain cart 110 is about to tip over. Thus, a feedback signal can be used by propulsion vehicle speed control system 122 to reduce the current target speed of material transfer vehicle 106 until the wheels both have sufficient weight on them to ensure that grain cart 110 will not tip over. This is just one example of the feedback that can be used by propulsion vehicle speed control system 122 to verify or modify the current target speed of material transfer vehicle 106.

With respect to the present description, it will be noted that propulsion vehicle speed control system 122 can be located in various different locations. Propulsion vehicle speed control system 122 can be located on propulsion vehicle 108, on a remote system, on another vehicle, or distributed. For instance, portions of propulsion vehicle speed control system 122 may be located on propulsion vehicle 108 while other parts are located on grain cart 110, on haulage vehicle 118, on harvester 102, or in a remote server environment. Propulsion vehicle speed control system 122 is shown at a single location for the sake of example only.

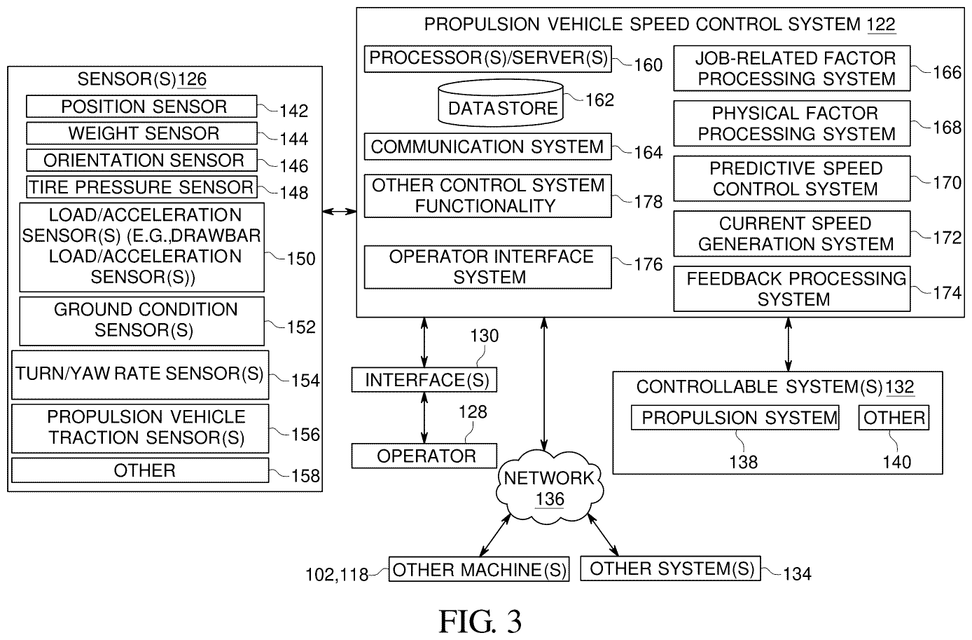

FIG. 3 is a block diagram showing one example of a portion of agricultural system 100 in more detail. FIG. 3 shows that propulsion vehicle speed control system 122 receives one or more inputs from a plurality of different sensors 126 and may receive inputs from an operator 128 through an interface 130. FIG. 3 also shows that propulsion vehicle speed control system 122 generates control signals that are provided to control one or more controllable systems 132. Further, FIG. 3 shows that propulsion vehicle speed control system 122 can communicate with other machines 102, 118 and/or other systems 134 over a network 136.

In one example, network 136 may be a wide area network, a local area network, a cellular communication network, a Wi-Fi or Bluetooth network, a near field communication network, or any of a variety of other networks or combinations of networks.

Other systems 134 may be farm manager systems, systems located in remote server environments or on other machines, or other systems.

In one example, the controllable systems 132 include a propulsion system 138 that is used by propulsion vehicle 108 to generate propulsion. Therefore, propulsion system 138 may be an internal combustion engine, an electric motor, a transmission, individual drive motors, or other devices that can be used to generate propulsion of propulsion vehicle 108. The controllable systems 132 can include other controllable systems 140 as well. As described previously, it will be understood that in some examples a material transfer vehicle may be self-propelled, that is, the propulsion system 138 and material container are part of the same machine rather than being separated between a towing machine and a towed machine.

In the example shown in FIG. 3, sensors 126 can include position sensor 142, one or more weight sensors 144, orientation sensor 146, tire pressure sensor 148, load/acceleration sensors (e.g., drawbar load/acceleration sensors, etc.) 150, ground condition sensors 152, turn/yaw rate sensors 154, propulsion vehicle traction sensors 156, and/or any of a wide variety of other sensors 158.

Propulsion vehicle speed control system 122 can include one or more processors or servers 160, data store 162, communication system 164, job-related factor processing system 166, physical factor processing system 168, predictive speed control system 170, current speed generation system 172, feedback processing system 174, operator interface system 176, and other system functionality 178. Before describing the overall operation of architecture 100 in more detail, a description of some of the items in architecture 100, and their operation, will first be provided.

Position sensor 142 senses the position of material transfer vehicle 108 in a global or local coordinate system. Therefore, position sensor 142 may be a Global Navigation Satellite System (GNSS) receiver, a cellular triangulation system, a dead reckoning system, or any of a wide variety of other positioning systems. Weight sensor 144 generates an output indicative of weight. One or more weight sensors 144 can be mounted, for instance, as load cells in the axles of grain cart 110 or elsewhere. Weight sensors 144 thus provide an output indicative of the weight of grain cart 110 over the wheels. Orientation sensor 146 may be an inertial measurement unit (IMU), a gyroscopic sensor, a sensor that derives the orientation from the output of position sensor 142, or any of a wide variety of other sensors that provide the three-dimensional orientation of the sensor 146 (and thus the vehicle to which it is mounted). Tire pressure sensor 148 senses the pressure in one or more of the tires on grain cart 110. Load/acceleration sensors 150 are mounted on material transfer vehicle 106, such as mounted on propulsion vehicle 108 or grain cart 110, or both. Sensors 150 generate an output indicative of the load and/or accelerations experienced by the sensors 150. For instance, the load/acceleration sensors 150 may be mounted on the drawbar of propulsion vehicle 108 and thus sense the load or accelerations encountered by the drawbar. Accelerations may be in multiple axes, such as one or more of vertical accelerations, lateral accelerations, and longitudinal accelerations. The output from sensors 150 may be indicative of the ride quality or the smoothness of the terrain over which material transfer vehicle 106 is traveling. Sensors 150 can be inertial measurement units or accelerometers (e.g., multi-axis accelerometers). Ground condition sensors 152 sense various ground conditions and provide outputs indicative of those conditions. Thus, ground condition sensors 152 may sense the moisture of the soil or ground over which material transfer vehicle 106 is traveling, the slope or evenness of the terrain, or other ground conditions. Turn/yaw rate sensors 154 may generate an output indicative of the turning angle or yaw rate experienced by material transfer vehicle 106 as it is making a turn. Thus, turn/yaw rate sensors 154 may be angle encoders that since the turning angle of the wheels of tractor 108 relative to the frame, or inertial measurement units, or other accelerometers or other sensors that generate an output indicative of how quickly or sharply material transfer vehicle 106 is turning. Propulsion vehicle traction sensors 156 may generate an output indicative of the slippage of wheels on propulsion vehicle 108 or other outputs from a traction control system or other traction indicators.

Communication system 164 illustratively enables communication of the various items in agricultural system 100 with respect to one another. Therefore, communication system 164 may be a controller area network (CAN) bus and bus controller, a communication system that facilitates communication over network 136, such as a cellular communication system, a near field communication system, a Bluetooth or Wi-Fi communication system, a wide area network communication system, local area network communication system, or any of a variety of other communication systems or combinations of systems.

Operator interface system 176 includes interface mechanisms that can be used by operator 128. Operator 128 me may be a manual operator, an automated operator, or a semi-automated operator. The operator interface mechanisms in operator interface system 176 can include a steering wheel, joysticks, levers, pedals, knobs, buttons, or other input mechanisms. Further, the interface mechanisms can include a display screen that displays information on interfaces 130 for operator 128 and may receive inputs from operator 128. For instance, a display may include actuatable elements such as icons, links, buttons, etc. The display screen may be a touch sensitive display screen and the interface mechanisms may also include voice-related mechanisms, such as microphone, speaker, speech synthesis functionality, speech recognition functionality, among other things. Thus, the actuatable elements may be actuated by operator 128 using a point-and-click device, touch gestures, voice commands, etc.

Job-related factor processing system 166 accesses or detects job-related factors and processes those factors to generate an output that can be used by predictive speed control system 178 and current speed generation system 172. Physical factor processing system 168 detects or accesses physical factors and generates an output that can also be used by predictive speed control system 170 and current speed generation system 172.

The job-related factors that may be detected or accessed by job-related factor processing system one 166 can be factors corresponding to the harvesting operation or other operation being performed in conjunction with material transfer vehicle 106. For instance, job-related factors can include an indicator provided by haulage vehicle 118 indicating the status of haulage vehicle 118, such as whether haulage vehicle 118 is waiting to receive material from a material transfer vehicle 106. Thus, the job-related factor processing system 166 may receive an automated or manual communication from a haulage vehicle 118 over communication system 164 indicating the position of haulage vehicle 118 and the current fill level of haulage vehicle 118. In another example, the job-related factors may include an indicator indicating when combine harvester 102 is full and needing to unload harvested material into a material transfer vehicle 106. The job-related factor processing system 166 may also receive a job-related factor indicative of the position of agricultural harvester 102. The job-related factors can include the system harvest or haul rate that indicates the current rate or target rate at which material is being harvested and transferred out of the field. The job-related factors may also include an indicator indicating whether load data is being collected. For instance, if load data is to be collected, then material transfer vehicle 106 may be required to stop, when it is filled with material, so that the material can be weighed. Then, after unloading material into haulage vehicle 118, material transfer vehicle 106 may again need to stop so that another weight measurement can be taken to obtain the weight of the transferred material. These and other job-related factors are considered by job-related factor processing system 106 in determining how fast material transfer vehicle 106 should be moving.

Physical factor processing system 168 detects or accesses physical factors and processes those factors to generate an output indicative of how fast material transfer vehicle 106 should be traveling given the physical factors. Thus, the physical factors may include the current position of material transfer vehicle 106 output by position sensor 142 along with a map input indicating the terrain at the current location of material transfer vehicle 106. The physical factors may include the weight of material in grain cart 110 is output by weight sensors 144, as well as the orientation of grain cart 110 output by orientation sensors 146. The physical factors may include tire pressure of the tires on grain cart 110 output by tire pressure sensor 148 as well as the load and/or accelerations sensed by load/acceleration sensors 150. The physical factors may include the ground conditions as detected by ground condition sensors 152 and the turn or yaw rate sensed by turn/yaw rate sensors 154. The physical factors may include the traction or wheel slip that may be indicated by the output of propulsion vehicle traction sensors 156 as well as any of a wide variety of other physical factors.

Based upon the outputs from job-related factor processing system 166 and physical factor processing system 168, current speed generation system 172 generates an output indicative of a current target ground speed for material transfer vehicle 106. That output can be used to generate a control signal that is provided to propulsion system 138 to control the ground speed of material transfer vehicle 106.

Predictive speed control system 170 also receives the outputs from job-related factor processing system 166 and physical factor processing system 168, as well as other predictive factors, such as an indication of the route of material transfer vehicle 106, the slope of the terrain ahead of material transfer vehicle 106 along the route, the terrain conditions, an indication of the future state of grain cart 110 (such as whether it will be loaded, unloaded, the location of its center of gravity, etc.), and/or other predictive factors. Predictive speed control system 170 generates an output indicative of the future target speed of material transfer vehicle 106 as it moves along its projected route (the predictive speed). Current speed generation system 172 can also consider the predictive speed output by predictive speed control system 170 in generating the current speed control signal.

Feedback processing system 174 detects or accesses feedback factors and provides a feedback output to current speed generation system 172. The feedback output can indicate whether the current target speed of material transfer vehicle 106 (that is currently being commanded by current speed generation system 172) should be modified. For instance, the feedback signal may be indicative of a condition under which the current target speed should be reduced. By way of example, assume that the weight sensors 144 on the axles of grain cart 110 show that one of the wheels is about to lose contact with the ground. In that case, feedback processing system 174 may provide an output to current speed generation system 172 indicating that the current target speed of material transfer vehicle 106 should be reduced. Feedback processing system 174 may continue to provide such feedback (a “reduce speed” feedback) to current speed generation system 172 until the weight sensors indicate that the grain cart 110 is no longer in danger of tipping over. Current speed generation system 172 can then react to the feedback signal provided by feedback processing system 174 to modify the current target speed of material transfer vehicle 106 accordingly.

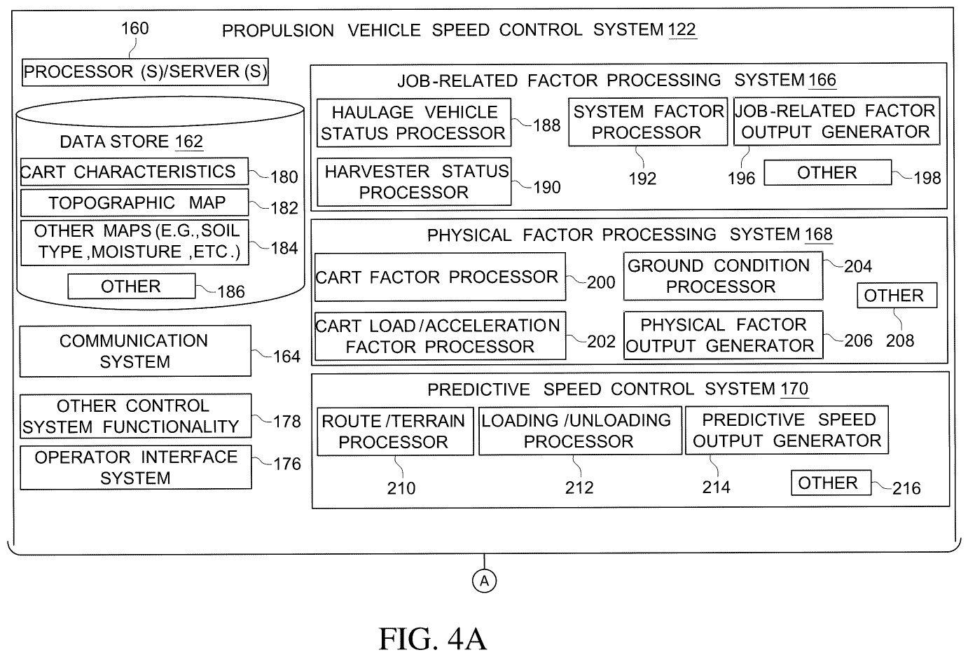

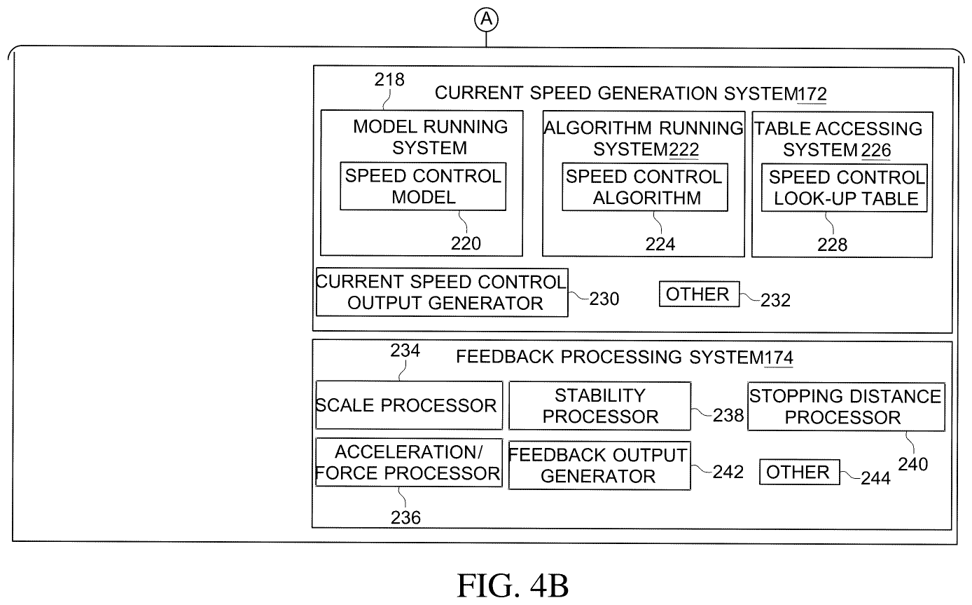

FIGS. 4A and 4B (collectively referred to as FIG. 4) illustrate a block diagram showing one example of propulsion vehicle speed control system 122 in more detail. In the example shown in FIG. 4, data store 162 includes cart characteristics 180, topographic map 182, other maps (such as so soil type maps, moisture maps, etc.) 184 and other items 186. Job-related factor processing system 166 includes haulage vehicle status processor 188, harvester status processor 190, system factor processor 192, job-related factor output generator 196, and other items 198. Physical factor processing system 168 includes cart factor processor 200, cart load/acceleration processor 202, ground condition processor 204, physical tractor output generator 206, and other items 208. Predictive speed control system 170 includes route/terrain processor 210, loading/unloading processor 212, predictive speed output generator 214, and other items 216. Current speed generation system 172 includes model running system 218 which is configured to run a speed control model 220, algorithm running system 222 which is configured to run a speed control algorithm 224, table accessing system 226 which is configured to access a speed control look-up table 228, current speed control output generator 230, and other items 232.

Feedback processing system 174 includes scale processor 234, acceleration/force processor 236, stability processor 238, stopping distance processor 240, feedback output generator 242, and other items 244. Before describing the operation of propulsion vehicle speed control system 122 in more detail, a description of some of the items in system 122, and their operation, will first be provided.

Cart characteristics 180 include physical characteristics of grain cart 110. Thus, cart characteristics 180 can include dimensions of cart 110 (such as the wheelbase, overall length, overall width, profile, and other dimensions). The physical characteristics of cart 110 can include an indicator indicating whether the grain cart 110 includes tires or tracks. The physical characteristics can include tire pressure, load capacity of grain cart 110, the weight of grain cart 110, the carrying capacity of grain cart 110, and/or other cart characteristics.

Topographic map 182 includes a topographical map of the field or area over which material transfer vehicle 106 is traveling. The topographic map 182 may also include other information such as where the slope exceeds a threshold slope, or other information. Other maps 184 can include a variety of other geo-referenced characteristics that are referenced to the field or area over which material transfer vehicle 106 is traveling. Such maps can include a coverage map which indicates which parts of the field have been harvested, a soil type map, soil moisture map, a map of obstacles in the field, a map of different areas within the field such as headlands, waterways, field roads, muddy areas or other low traction areas, or any of a variety of other maps.

In job-related factor processing system 166, haulage vehicle status processor 188 detects or accesses status information corresponding to haulage vehicles 118. The status information can include the percent full for each haulage vehicle 118, the location of each haulage vehicle 118, the travel status of the haulage vehicle 118 (such as whether it is en route to or away from the field), timing indicators (such as an indicator indicating how long a haulage vehicle 118 has been waiting to be loaded), or other haulage vehicle status information.

Harvest harvester status processor 190 receives or accesses harvester status information, such as the location of harvester 102, the percent full corresponding to the clean grain tank on harvester 102, whether harvester 102 is waiting to be unloaded or is traveling, or any of a wide variety of other harvester status information. System factor processor 192 receives and processes system information, such as the overall harvest rate or haul rate at which material is being transported out of the field being harvested. The system factors can also include an indicator identifying whether each load of grain cart 110 is being weighed, and other system information.

Each of the processors 188, 190, and 192 process the factors that they receive or detect and generate an output to job-related factor output generator 196. Generator 196 may be a classifier, such as a machine learning classifier, and artificial intelligence (AI) generative model, or another generator that receives inputs from haulage vehicle status processor 188, harvester status processor 190, and system factor processor 192 and generates an output indicative of a speed at which material transfer vehicle 106 can travel. For instance, assume that material transfer vehicle 106 is filled and traveling toward haulage vehicle 118 to unload. Then, if the haulage vehicle status processor 188 generates an output indicating that a haulage vehicle 118 is waiting to be loaded and harvester status processor 190 indicates that harvester 102 is also waiting to be unloaded, then job-related factor output generator 196 may generate an output indicating that material transfer vehicle 106 should proceed at high speed to unload its material at haulage vehicle 118 and return at high speed to agricultural harvester 102. The output from generator 196 can be generated in terms of a percent of maximum speed of material transfer vehicle 106, or as another output.

In physical factor processing system 168, cart factor processor 200 receives the cart characteristics 180 from sensors 126 indicative of cart characteristics (such as cart weight from weight sensors 144, cart orientation from orientation sensor 146, cart tire pressure from tire pressure sensor 148) and generates an output based upon those cart factors. Cart factor processor 200 can also receive inputs from other sensors 126, such as the turn angle or yaw rate of material transfer vehicle 106 generated my turn/yaw rate sensors 154. Cart load/acceleration processor 202 receives an input indicative of the load and/or acceleration characteristics on the drawbar or another portion of material transfer vehicle 106 and generates an output based on those inputs. The load and/or acceleration characteristics can be detected, for instance, based upon the output from load/acceleration sensors 150. Ground condition processor 204 receives an input indicative of ground conditions (from ground condition sensor 152, a topographic map, or other map) and generates an output based on those inputs. Ground condition processor 204 may also receive an input from propulsion vehicle traction sensors 156 indicating areas where wheel slip occurred, where muddy conditions exist, etc. Based upon the output from processors 200, 202, and 204, physical factor output generator 206 generates an output indicative of the speed at which material transfer vehicle 106 should be traveling, given the physical factors.

For instance, if the cart factor processor 200 generates an output indicating that the grain cart 110 is empty, and if ground condition processor 204 generates an output indicating that the ground conditions are level and dry, and if cart load/acceleration processor 202 generates an output indicating that the ride quality or roughness of the terrain over which material transfer vehicle 106 is moving is relatively smooth, then physical factor output generator 206 may generate an output indicating that the speed of material transfer vehicle 106 can be increased to its maximum speed. Physical factor output generator 206 may thus be a model that receives the outputs from the other processors 200, 202, and 204 and generates a corresponding output. The model may be an AI generative model, another machine learning model, or another type of classifier. Generator 206 may run an algorithm, use a look-up table, or generate the output on other ways.

In predictive speed control system 170, route/terrain processor 210 obtains an indication of the future route of propulsion vehicle 108 and an indication of the terrain along that route. Therefore, route/terrain processor 210 may receive an input from a path planning system that is being used to control the heading of propulsion vehicle 108, along with a topographical map that identifies the topography and/or terrain characteristics of the terrain on the route. Route/terrain processor 210 can process those inputs and generate an output indicative of a predicted target speed for propulsion vehicle 108. For instance, where the route is relatively straight (e.g., no sharp turns) and the terrain is relatively smooth and flat, then processor 210 may generate an output indicating that the future speed of material transfer vehicle 108 along the predicted route can be a maximum speed for material transfer vehicle 108. On the other hand, if the route shows that the material transfer vehicle will be taking one or more sharp turns, that the terrain is sloped or rough, or other factors indicating that the future speed of propulsion vehicle 108 should be reduced, then processor 210 can generate a corresponding output.

Loading/unloading processor 212 illustratively receives an input indicative of whether material transfer vehicle 106 is on its way to be loaded or to be unloaded. If material transfer vehicle 106 is on its way to be unloaded, then after it is unloaded, and when it is traveling along its future route, the grain cart 110 will be empty meaning that material transfer vehicle 106 may be able to travel more quickly. However, if the material transfer vehicle 106 is on its way to harvester 102 to be loaded with harvested material, then, as material transfer vehicle 106 is traveling along its future route, it will be heavier, and its center of gravity may be higher indicating that transfer vehicle 106 should travel more slowly. Predictive speed output generator 214 receives inputs from processors 210 and 212 and generates an output indicative of whether the predicted future target speed of material transfer vehicle 106 should be a high speed or a low speed. The output from predictive speed output generator 214 can be a speed value (e.g., in miles per hour or kilometers per hour), an indicator indicating that the speed should be high, medium, or low, an indicator indicating that the speed should be a certain percent of the maximum speed of material transfer vehicle 106, or another indicator.

Therefore, predictive speed output generator 214 can also be a model that receives the outputs from processors 210 and 212 and generates an output based on those inputs. The model can be of machine learning model, an AI generative model, or another type of model. In addition, predictive speed output generator 214 can access a lookup table based upon the inputs from processors 210 and 212, or run an algorithm based upon the inputs from processors 210 and 212, to generate its output.

Current speed generation system 172 receives the inputs from job-related factor output generator 196, physical factor output generator 206, and predictive speed output generator 214 and generates an output indicative of a current target speed for material transfer vehicle 108. Model running system 218 can run a speed control model 220 based upon the various inputs to generate a current target speed value indicative of the current target ground speed for material transfer vehicle 108. Speed control model 220 can be a machine learning model, an AI generative model, or another type of model that receives the outputs from systems 166, 168, and 170 and generates a speed control output. Algorithm running system 222 can run a speed control algorithm 224 based upon the outputs from systems 166, 168, and 170. The speed control algorithm 224 may be a rules-based algorithm or another type of static or dynamic algorithm that receives the inputs from systems 166, 168, and 170 and generates an output indicative of a current target ground speed for material transfer vehicle 106. Table accessing system 226 can access a speed control lookup table 228 based upon the outputs from systems 166, 168 and 170, and identify a current target speed for material transfer vehicle 106. For instance, speed control lookup table 228 may include a table of speed values indexed based upon the values output from systems 166, 168, and 170. Upon receiving those values, table accessing system 226 can search into speed control lookup table 228 to identify a ground speed value for material transfer vehicle 106.

Current speed control output generator 230 generates an output indicative of the current target ground speed for material transfer vehicle 106. The output can be a speed control signal that is provided to control propulsion system 138 or another output. Current speed control output generator 230 generates the output based upon the current target speed value received from one or more of systems 218, 222, and 226. The output signal may be a control signal that is used to control propulsion system 138 on propulsion vehicle 108, or another type of output.

In feedback processing system 174, scale processor 234 may receive inputs from weight sensors 144 (which may be scales that identify the weight on the different tires of grain cart 110). Scale processor 234 may process those inputs and generate an output indicating whether the current target speed should be modified (e.g., increased or decreased). Acceleration/force processor 236 can receive an input indicative of the load or accelerations on the material transfer vehicle 106 (e.g., load or accelerations on drawbar of material transfer vehicle 106 or other accelerations or forces on material transfer vehicle 106) and generate an output indicative of whether the current target speed should be modified. For instance, if load/acceleration sensors 150 are providing an output indicating that there are a high level of load changes or accelerations being experienced by material transfer vehicle 106 (e.g., by the drawbar on propulsion vehicle 108), this may indicate that material transfer vehicle 106 is traveling over very rough terrain, in which case the speed should be reduced. This is just one example. Stability processor 238 can receive other inputs that may be used to calculate such things as the center of gravity of grain cart 110, whether propulsion vehicle 108 is experiencing wheel slip, whether grain cart 110 is about to tip over, or other inputs. Such inputs may be received, for instance, from ground conditions sensors 152, turn/yaw rate sensors 154, orientation sensor 146, weight sensors 144, or other sensors. In addition, stopping distance processor 240 may receive various inputs from sensors, maps, or other inputs and calculate an estimated stopping distance for material transfer vehicle 106. The stopping distance may consider the weight of the various components of material transfer vehicle 106, the slope of the terrain over which material transfer vehicle 106 is traveling, the soil conditions, whether propulsion vehicle 108 is experiencing wheel slip, and/or any of a wide variety of other factors. Based upon those factors, stopping distance processor 240 generates an output indicative of the current stopping distance required by material transfer vehicle 106 to come to a stop.

Feedback output generator 242 receives the inputs from processors 234, 236, 238, and 240 and generates an output indicating whether the current target speed of material transfer vehicle 106 should be increased, decreased, or maintained. Feedback output generator 242 may thus be a machine learning model, a generative AI model, a rules - based system, an algorithm, or another type of generator that generates an output indicating whether the current target speed of material transfer vehicle 106 should be modified or retained.

Feedback output generator 242 can provide an output in different ways. The output may be a speed value indicating a recommended ground speed for material transfer vehicle 106, a percentage value indicating the percent of maximum speed suggested, an accelerate/decelerate indicator indicative of whether the current target speed should be increased or decreased, or another type of output. Current speed generation system 172 can then consider the output from feedback processing system 174 in setting the current target speed for material transfer vehicle 106.

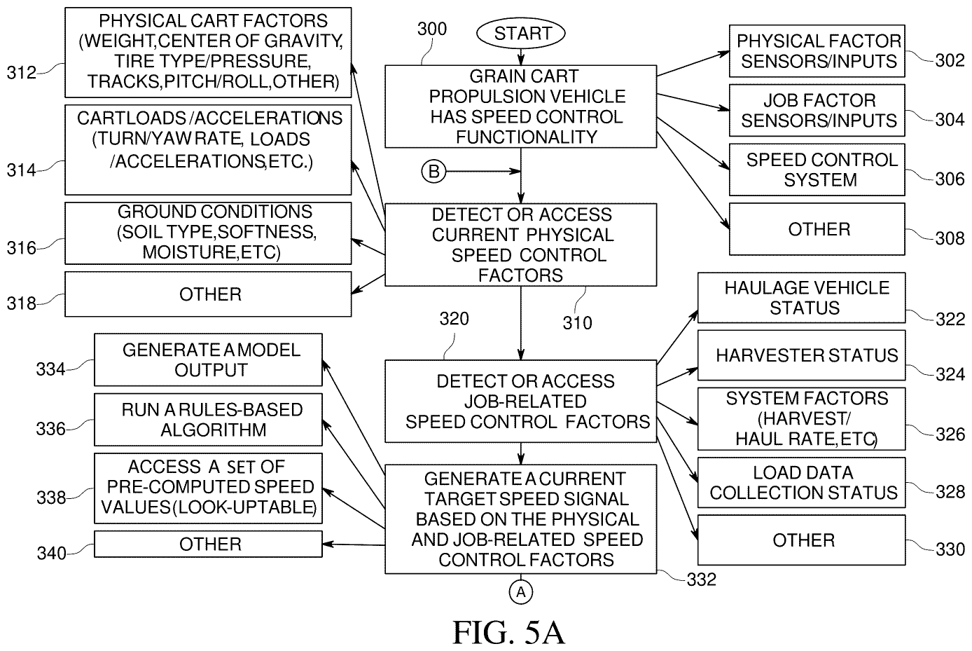

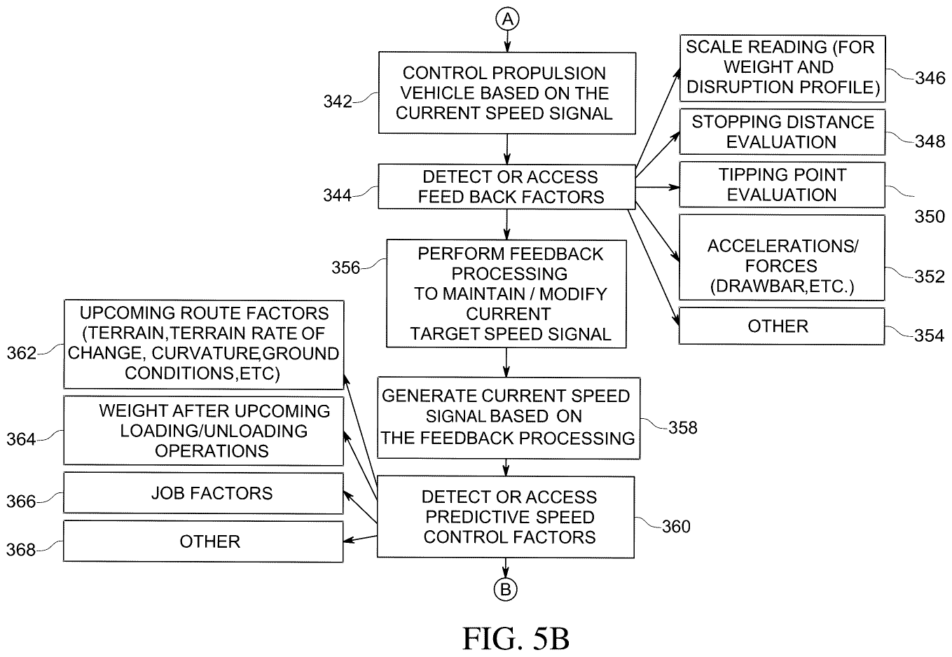

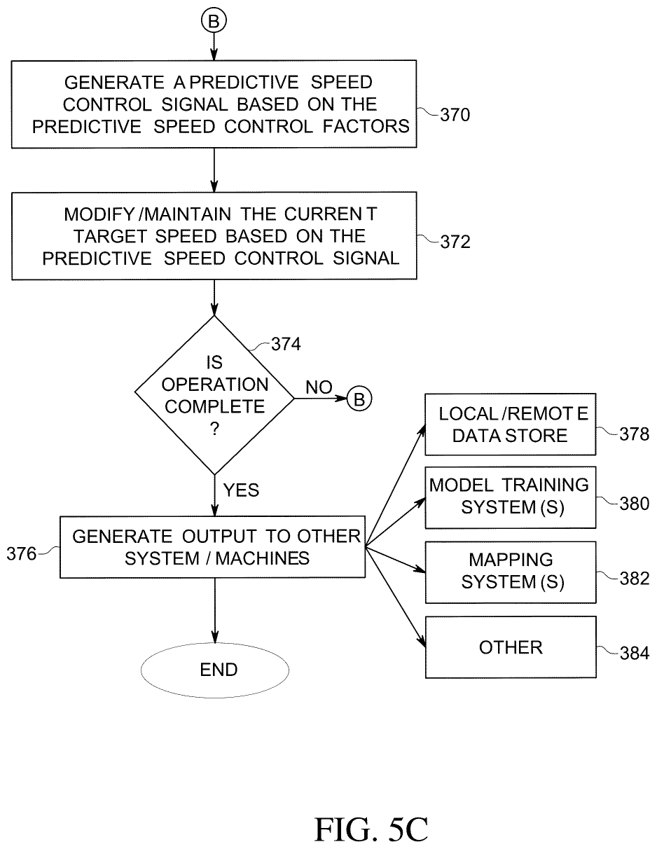

FIGS. 5A, 5B, and 5C (collectively referred to herein as FIG. 5) show one example of a flow diagram illustrating the operation of agricultural system 100 and propulsion vehicle speed control system 122. It is first assumed that a propulsion vehicle 108 is pulling a grain 110 cart and has or has access to speed control functionality, as indicated by block 300 in the flow diagram of FIG. 5. In one example, the propulsion vehicle 108 has physical factor sensors and/or inputs as indicated by block 302. The propulsion vehicle 108 also illustratively has job-related factor sensors or inputs as indicated by block 304. The propulsion vehicle 108 also has a propulsion vehicle speed control system 122, or is in communication with such a system 122, as indicated by block 306. The propulsion vehicle 108 can be configured in other ways as well, as indicated by block 308.

One or more different sensors then detect current physical speed control factors as indicated by block 310. The physical speed control factors can include cart factors (such as weight, center of gravity, tire type/pressure, an indication as to whether tires or tracks are used, the grain cart orientation (such as pitch/roll)) and/or other physical factors as indicated by block 310. The physical factors can also include the loads or accelerations that are experienced by material transfer vehicle 106 (e.g., by grain cart 110 and/or propulsion vehicle 108). Such loads and/or accelerations can include the turn or yaw rate and drawbar loads or accelerations (e.g., vertical drawbar loads or accelerations), among other things, as indicated by block 314. The physical factors can also include such things as ground conditions (e.g., soil type, soil softness, soil moisture, etc.) as indicated by block 316. The physical factors can be detected in other ways and can include other factors as well, as indicated by block 318.

Job-related factor processing system 166 then detects or receives job-related speed control factors, as indicated by block 320. Such factors can include the haulage vehicle status 322 (which may be communicated from the haulage vehicle 118 itself, from an operator, or in other ways), the harvester vehicle status 324 (which also may be communicated by the operator of a harvester, or in other ways), system factors (such as the overall harvest or haul rate of harvested material from the field) as indicated by block 326, and the load data collection status (such as whether the load weight is being collected from the grain cart 110 or material transfer vehicle 106) as indicated by block 328, and/or any of a wide variety of other job-related speed control factors which may be detected or accessed in other ways, as indicated by block 330.

Current speed generation system 172 then automatically generates a current target speed signal based upon the physical and job-related speed control factors, as indicated by block 332 in the flow diagram of FIG. 5. By automatically it is meant, for example, that the step, function or process is performed without further human involvement except, perhaps, to initiate or authorize the step, function, or process. For instance, model running system 218 can generate a model output, as indicated by block 334. Algorithm running system 222 can generate an output by running a speed control algorithm 224 which may be a rules-based algorithm or another algorithm, as indicated by block 336. Table accessing system 226 can access a speed control lookup table 228 two obtain a pre-computed speed control value, as indicated by block 338. Current speed generation system 172 can generate a current target speed signal based upon the physical and job-related factors in other ways as well, as indicated by block 340.

Current speed control output generator 230 then generates a control signal to automatically control propulsion system 138 on propulsion vehicle 108 based upon the current target speed signal as indicated by block 342 in the flow diagram of FIG. 5.

Feedback processing system 174 can also detect feedback factors so that current speed generation system 172 can modify the current target speed signal based upon feedback. Detecting feedback factors as indicated by block 344 in the flow diagram of FIG. 5. Scale processor 234 can generate feedback based on scale readings as indicated by block 346. Stability processor 238 can generate an output indicative of whether grain cart 110 is about to tip over or is unstable in another way. Performing a stability or tipping point evaluation is indicated by block 348 in the flow diagram of FIG. 5. Stopping distance processor 240 may calculate the current stopping distance for material transfer vehicle 106 and compare that to a desired stopping distance threshold or evaluate the stopping distance in another way, as indicated by block 350. Acceleration/force processor 236 can receive sensor signals indicative of accelerations and forces (e.g. exerted on the drawbar of material transfer vehicle 106 or in other ways) and generate feedback based on those accelerations or forces, as indicated by block 352 in the flow diagram of FIG. 5. Feedback processing system 174 can detect other feedback factors and generate feedback indicators based on those factors as well, as indicated by block 354.

Feedback output generator 242 automatically performs feedback processing on the feedback factors and generates an output indicative of whether the current target speed should be maintained or modified as indicated by block 356 and the flow diagram of FIG. 5. Current speed generation system 172 then automatically generates the current target speed signal based upon the output from feedback processing system 174, as indicated by block 358. The current target speed signal can be increased, decreased, or maintained, based upon the feedback.

Predictive speed control system 170 can also detect or access predictive speed control factors to perform predictive speed control processing, as indicated by blocks 360 in the flow diagram of FIG. 5. For instance, route/terrain processor 210 can compute or access the upcoming route of material transfer vehicle 106, along with terrain or other characteristics of that route, as indicated by block 362 in the flow diagram of FIG. 5. For instance, the characteristics of the route may include the terrain, the rate of change of the terrain, the curvature or turn angles along the route, the ground conditions along the route, etc.

Loading/unloading processor 212 can detect or access the weight of grain cart 110 after any imminent operations are performed (such as a loading operation in which grain cart 110 is loaded with harvested material from harvester 102 or an unloading operation in which harvested material is unloaded from grain cart 110 into haulage vehicle 118). Detecting the weight that may be changed based on imminent operations is indicated by block 364 in the flow diagram of FIG. 5.

Predictive speed control system 170 can also detect or access job-related factors, such as the status of haulage vehicles 118, the status of harvester 102, or other job-related factors, as indicated by block 366. Predictive speed control system 170 can detect or access any of a wide variety of other predictive speed control factors as well, as indicated by block 368.

Predictive speed output generator 214 then automatically generates a predictive speed control signal based upon the predictive speed control factors, as indicated by block 370 in the flow diagram of FIG. 5. Current speed generation system 172 can then automatically modify or maintain the current target speed, as desired, based upon the predictive speed control output generated by predictive speed output generator 214. For instance, if material transfer vehicle 106 is about to encounter a steep side slope on its route back to haulage vehicle 118, then the predictive speed control output from generator 214 may indicate that the current target speed should be reduced before material transfer vehicle 106 reaches the location of the steep side slope. Current speed generation system 172 can then command the current target speed to be reduced ahead of that location. Computing the current target speed based upon the output from the predictive speed output generator 214 is indicated by block 372 in the flow diagram of FIG. 5.

Until the operation of material transfer vehicle 106 is complete, as determined at block 374, processing reverts to block 310 where propulsion vehicle speed control system 122 continues to detect or access the current physical speed control factors, the job-related speed control factors, etc. If, at block 374, it is determined that the operation is complete, then propulsion vehicle speed control system 122 can use communication system 164 to generate outputs to other systems 134 and/or other machines 102, 118, etc., as indicated by block 376 in the flow diagram of FIG. 5. For instance, the current target speed outputs can be geo-referenced and output to a local or remote data store, along with the physical speed control factors and the job-related speed control factors (and/or other data) for access by other machines, as indicated by block 378. The geo-referenced target speed control values (and/or other data) can be used to train the various models in propulsion vehicle speed control system 122, as indicated by block 380. The geo-referenced speed control values (and/or other data) can be output to a mapping system which can be used to generate a speed map or another map, as indicated by block 382. Other outputs can be generated and sent to other machines or systems as well, as indicated by block 384.

It can thus be seen that the present description describes a system in which a propulsion vehicle speed control system 122 accesses not only physical factors but also job-related factors and controls the speed of a propulsion vehicle based upon those factors. The speed control can also be modified based on real time feedback signals and/or based on a predictive speed control signal that is generated based upon a future route of the material transfer vehicle 106, as well as future operations (e.g., load or unload operations) that are performed with respect to the material transfer vehicle. This enables the material transfer vehicle to be operated at a highest ground speed desired, given the physical and job-related factors that are relevant to speed control. This increases the efficiency of the harvesting operation and the fuel efficiency for the material transfer vehicle 106, reduces operator fatigue, and increases overall harvesting efficiency in other ways as well.

The present discussion has mentioned processors and servers. In one example, the processors and servers include computer processors with associated memory and timing circuitry, not separately shown. The processors or servers are functional parts of the systems or devices to which they belong and are activated by and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, and/or logic. It will be appreciated that such systems, components, generators, and/or logic can be comprised of hardware items (such as processors and associated memory, or other processing components, some of which are described below) that perform the functions associated with those systems, components, generators, and/or logic. In addition, the systems, components, generators, and/or logic can be comprised of software that is loaded into a memory and is subsequently executed by a processor or server, or other computing component, as described below. The systems, components, generators, and/or logic can also be comprised of different combinations of hardware, software, firmware, etc., some examples of which are described below. These are only some examples of different structures that can be used to form the systems, components, generators, and/or logic described above. Other structures can be used as well.

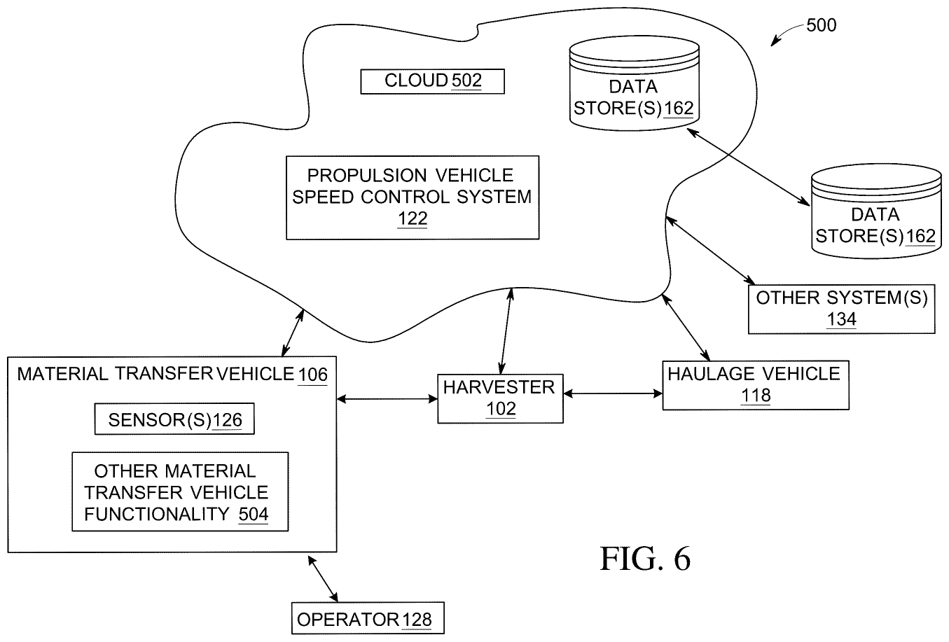

FIG. 6 is a block diagram of agricultural system 100, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 6, some items are similar to those shown in previous FIGS. and they are similarly numbered. FIG. 6 specifically shows that propulsion system speed control system 122 (or parts of system 122) or data store 162, and/or other systems 134 can be located at a remote server location 502. Therefore, material transfer vehicle 106 accesses those systems through remote server location 502. FIG. 6 shows that some or all of the sensors 126 and/or other material transfer vehicle functionality 504 can be located on material transfer vehicle 106 as well.

FIG. 6 also depicts another example of a remote server architecture. FIG. 6 shows that it is also contemplated that some elements of previous FIGS are disposed at remote server location 502 while others are not. By way of example, other systems 134 and/or data store 162 can be disposed at a location separate from location 502, and accessed through the remote server at location 502. Regardless of where the items are located, they can be accessed directly by material transfer vehicle 106, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

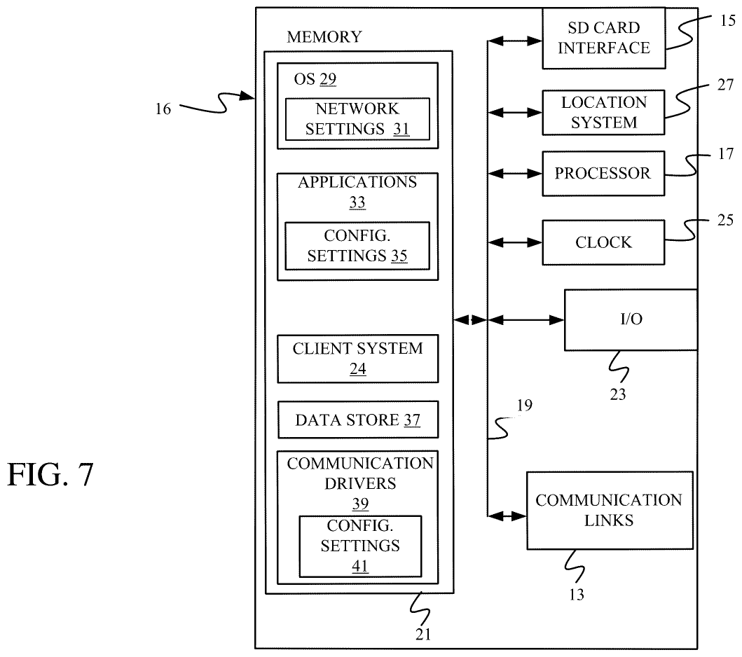

FIG. 7 is a simplified block diagram of one illustrative example of a handheld or mobile computing device that can be used as a user's or client's handheld device 16, in which the present system (or parts of it) can be deployed. For instance, a mobile device can be deployed in the operator compartment of propulsion vehicle 108 for use in generating, processing, or displaying the speed data. FIGS. 7-9 are examples of handheld or mobile devices.

FIG. 7 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

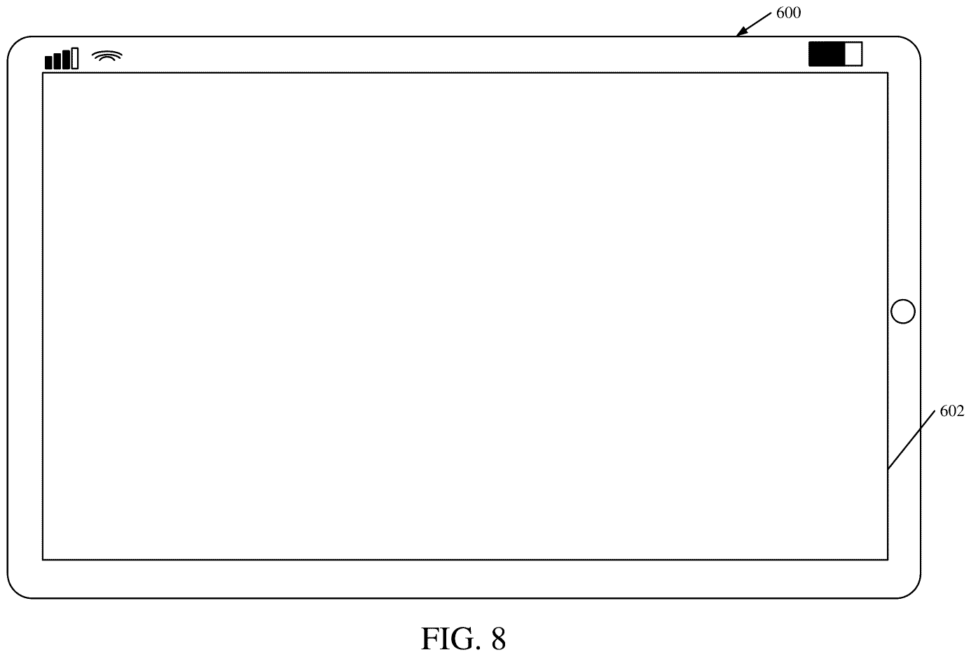

FIG. 8 shows one example in which device 16 is a tablet computer 600. In FIG. 8, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

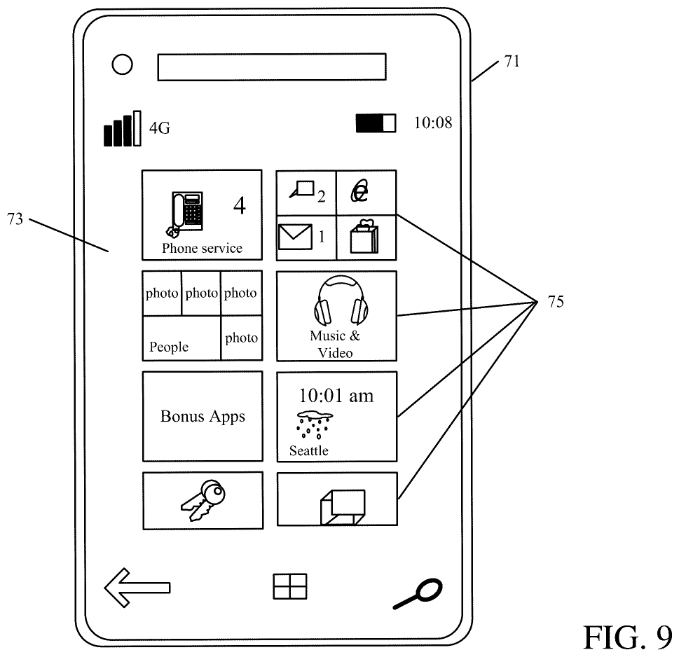

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

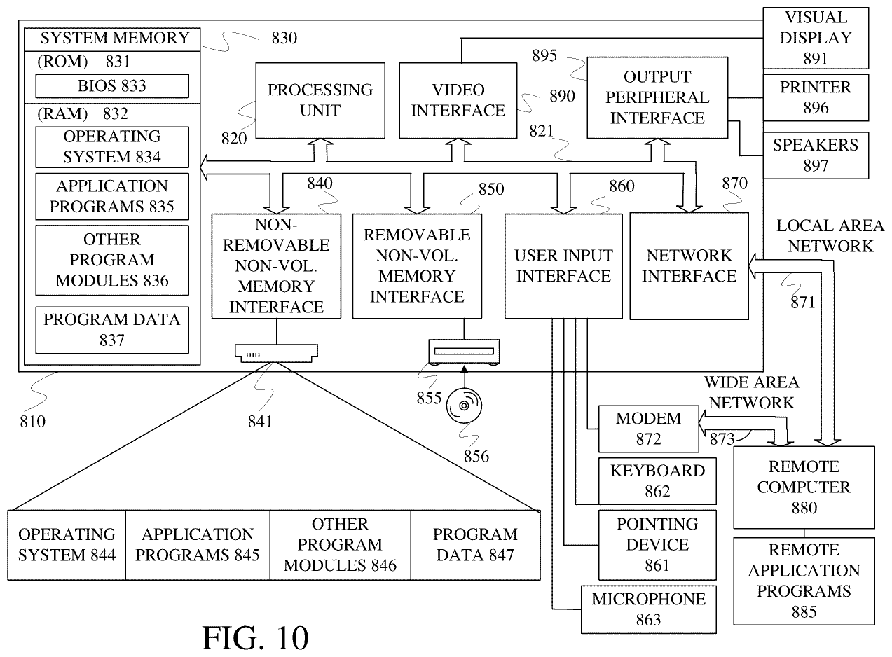

FIG. 10 is one example of a computing environment in which elements of previous FIGS., or parts of it, (for example) can be deployed. With reference to FIG. 10, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 10 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
detecting a physical speed control factor corresponding to an agricultural material transfer vehicle;
obtaining a job-related speed control factor corresponding to the agricultural material transfer vehicle;
automatically generating a target speed signal based on the physical speed control factor and the job-related speed control factor; and
controlling a propulsion system on the agricultural material transfer vehicle based on the target speed signal.

2. The computer implemented method of claim 1 and further comprising:
detecting a feedback speed control factor corresponding to the agricultural material transfer vehicle, during operation of the agricultural material transfer vehicle; and
wherein automatically generating the target speed signal comprises automatically generating the target speed signal based on the feedback speed control factor.

3. The computer implemented method of claim 2 and further comprising:
detecting a predictive speed control factor corresponding to the agricultural material transfer vehicle; and
wherein automatically generating the target speed signal comprises automatically generating the target speed signal based on the predictive speed control factor.

4. The computer implemented method of claim 1 wherein the agricultural material transfer vehicle comprises a cart and a propulsion vehicle and wherein detecting the physical speed control factor comprises:
detecting a plurality of cart factors corresponding to the cart; and
generating a physical speed control output based on the plurality of cart factors.

5. The computer implemented method of claim 4 wherein detecting a plurality of cart factors comprises:
detecting two or more of cart weight, cart center of gravity, cart pitch and roll orientation, turning angle, yaw rate, acceleration, and drawbar load.

6. The computer implemented method of claim 4 wherein detecting the physical speed control factor comprises:
detecting ground conditions corresponding to ground over which the agricultural material transfer vehicle travels.

7. The computer implemented method of claim 1 wherein the agricultural material transfer vehicle is configured to transfer harvested material from a harvester to a haulage vehicle and wherein obtaining job-related factors comprises:
obtaining a haulage vehicle status indicator indicative of whether the haulage vehicle is in position to receive the harvested material from the agricultural material transfer vehicle.

8. The computer implemented method of claim 1 wherein the agricultural material transfer vehicle is configured to transfer harvested material from a harvester to a haulage vehicle and wherein obtaining job-related factors comprises:
obtaining a harvester status indicator indicative of whether the harvester is ready to transfer the harvested material to the agricultural material transfer vehicle.

9. The computer implemented method of claim 3 wherein detecting a predictive speed control factor comprises:
detecting a route for the agricultural material transfer vehicle;
detecting characteristics of the route; and
generating a predictive speed control output based on the route and the characteristics of the route.

10. The computer implemented method of claim 1 wherein automatically generating the target speed signal comprises:
applying an indication of the physical speed control factor and an indication of the job-related speed control factor as inputs to a machine learning model; and
generating a representation of the target speed signal with the machine learning model.

11. The computer implemented method of claim 1 wherein automatically generating the target speed signal comprises:
applying an indication of the physical speed control factor and an indication of the job-related speed control factor as inputs to a speed control algorithm; and
generating a representation of the target speed signal with the speed control algorithm.

12. The computer implemented method of claim 1 wherein automatically generating the target speed signal comprises:
searching a speed control look-up table based on the physical speed control factor and based on an indication of the job-related speed control factor to identify a representation of the target speed signal.

13. An agricultural system, comprising:
an agricultural material transfer vehicle configured to transfer harvested material from a harvester to a haulage vehicle;
a physical factor processing system configured to detect a physical speed control factor corresponding to an agricultural material transfer vehicle and generate a physical factor output based on the physical speed control factor;
a job-related factor processing system configured to obtain a job-related speed control factor corresponding to the agricultural material transfer vehicle and generate a job-related factor output based on the job-related speed control factor;
a current speed generation system automatically generating a target speed signal based on the physical factor output and the job-related factor output; and
a current speed control output generator configured to control a propulsion system on the agricultural material transfer vehicle based on the target speed signal.

14. The agricultural system of claim 13 and further comprising:
a feedback processing system configured to detect a feedback speed control factor corresponding to the agricultural material transfer vehicle, during operation of the agricultural material transfer vehicle, and wherein the current speed generation system is configured to automatically generate the target speed signal based on the feedback speed control factor.

15. The agricultural system of claim 13 and further comprising:
a predictive speed control system configured to detect a predictive speed control factor corresponding to the agricultural material transfer vehicle and wherein the current speed generation system is configured to automatically generate the target speed signal based on the predictive speed control factor.

16. The agricultural system of claim 13 wherein the agricultural material transfer vehicle comprises a cart and a propulsion vehicle and wherein the physical factor processing system comprises:
a cart factor processor configured to detect a plurality of cart factors corresponding to the cart and generate a cart factor output based on the cart factors; and
a physical factor output generator configured to generate the physical factor output based on the cart factor output.

17. The agricultural system of claim 13 wherein the job-related factor processing system comprises:
a status processor configured to obtain at least one status indicator, the at least one status indicator being at least one of a haulage vehicle status indicator indicative of whether the haulage vehicle is in position to receive the harvested material from the material transfer vehicle or a harvester status indicator indicative of whether the harvester is ready to transfer the harvested material to the material transfer vehicle, the status processor being configured to generate a status processor output based on the at least one status indicator; and
a job-related output generator configured to generate the job-related factor output based on the status processor output.

18. The agricultural system of claim 15 wherein the predictive speed control system comprises:
a route processor configured to detect a route for the agricultural material transfer vehicle and a characteristic of the route; and
a predictive speed output generator configured to generate the predictive speed control factor based on the route and the characteristic of the route.

19. An agricultural vehicle control system, comprising:
at least one processor; and
memory storing computer executable instructions which, when executed by the at least one processor, cause the at least one processor to perform a method, comprising:
detecting a physical cart factor corresponding to an agricultural grain cart that is propelled by a propulsion vehicle to transfer harvested material from a harvester to a container during a harvesting operation;
obtaining a job-related speed control factor corresponding to the harvesting operation;
automatically generating a target speed signal based on the physical cart factor and the job-related speed control factor; and
controlling a speed of the propulsion vehicle based on the target speed signal.

20. The agricultural vehicle control system of claim 19 wherein the computer executable instructions which, when executed by the at least one processor, cause the at least one processor to perform the method, comprising:
detecting a feedback speed control factor corresponding to the grain cart during the harvesting operation;
detecting a predictive speed control factor; and
wherein automatically generating the target speed signal comprises automatically generating the target speed signal based on the feedback speed control factor and the predictive speed control factor.
